(19) United States
(12) Patent Application Publication
(10) Pub. No.: US 2016/0143793 A1
(43) Pub. Date: May 26, 2016

(54) Wheelchair with multiple replaceable seats

(71) Applicants: Steve Holub, El Cajon, CA (US); Kevin McKee, Hemet, CA (US)

(72) Inventors: Steve Holub, El Cajon, CA (US); Kevin McKee, Hemet, CA (US)

(21) Appl. No.: 14/544,110

(22) Filed: Nov. 24, 2014

(51) Int. Cl. A61G 5/12; A61G 5/10

(52) U.S. Cl. CPC A61G 5/12; A61G 5/1056; A61G 2005/124

(57) ABSTRACT

A single wheelchair selectively mounts at times each of a plurality of different wheelchair seats, one at a time, so as to customize seating upon and within the wheelchair as then best suits the preference of the user-occupant of the wheelchair. Seats support both formal and sport uses of the wheelchair. A detachable sport seat has in particular a deep contour seat base hinged to a deep contour seat back, providing thus substantial lateral support to a seated occupant of the wheelchair.

### REFERENCE TO RELATED APPLICATIONS

The present application is related to co-pending U.S. patent applications serial numbers AA/AAA,AAA for a REMOVABLE/REPLACEABLE WHEELCHAIR BUMPER, BB/BBB,BBB for PARA-ALPINE SIT-SKI SEAT RISES AND TILTS TO PERMIT HANDICAPPED SKIERS TO ASSUME SEATING IN STANDARD SKI SLOPE CHAIR LIFTS, UNASSISTED IF NEEDS BE, and CC/CCC,CCC for PARA-ALPINE SIT-SKI WITH INDEPENDENTLY QUICK-DETACHABLE AND RE-ATTACHABLE (1) OUTRIGGER SKIS, AND/OR (2) A “ROLL BAR” FOR GUIDANCE, all to the selfsame inventors as, and filed on an even date with, the present application. The contents of the related patent applications are incorporated herein by reference.

### BACKGROUND OF THE INVENTION

1. Field of the Invention

The present invention generally concerns wheelchairs, and particularly concerns the seats and the seating of wheelchairs.

The present invention particularly concerns wheelchairs with multiple seats that are any of (1) adjustable, (2) replaceable and (3) quick connect and disconnect.

2. Background of the Invention

2.1 Replaceable Seats

Persons who spend much of their waking time in wheelchairs are often quite particular about the (1) performance and/or (2) appearance of their wheelchairs, which can be both an extension of their (1) bodily mechanics and/or (2) extended personal appearance such as might normally be realized by clothing. Since much of a conventional wheelchair is constituted by its tubular metal (steel) frame, the wheelchair seat is one of the few areas in which its owner/occupant can show some originality.

Originality in the selection of a wheelchair seat may be directed to any combination of (1) function, (2) cost and wear, (3) appearance, and/or (4) special construction(s) as best suit special requirements of the wheelchair and wheelchair seat occupant. Since many wheelchair owners cannot afford large numbers, or even multiple, wheelchairs, it would be useful if wheelchair seats could serve multiple purposes or, forbearing that, that seats could be readily substituted upon a same wheelchair frame.

In so contemplating replaceable and substitutable wheelchair seats it should be appreciated that wheelchair seats are quite as different as, for example, footwear—which ranges from ballet slippers to motorcycle boots. Some seats are desirably very elegant, stylish, fancy and/or expensive—such as seats custom upholstered in fine leathers and fabrics that are used for special and formal occasions. These seats may be too delicate, damage prone, and/or expensive for everyday usage in the same manner that expensive dress shoes are seldom suitable for, and worn to, an everyday job—and vice versa. Some seats desirably offer special support features such as, by way of example, enhanced lateral support useful in wheelchair sports such as, by way of example, wheelchair basketball. A “deep-disk contour” plastic/fiberglass wheelchair sports seat that is eminently suitable for a sports environment may be manifestly unsuitable for a formal environments—such as attendance at a formal wedding—in a way that a utilitarian wheelchair frame is not.

Accordingly, it would be useful if a single wheelchair could not only mount different seats at different times, but if the wheelchair could mount these seats expediently, easily, positively, and well with both maximum strength and accurate positive alignment. In short it would be useful in so realizing a function of such importance if a substitutable wheelchair seat was not merely a matter of “attach seat here”, but if some considerable engineering thought and design was to be devoted to the realization of this objective in a manner that was all of safe, economical, easy, quick, strong, flexible and versatile, stylish, and downright satisfying. In this regard it will be understood that aftermarket specialty seats are widely sold for automobiles, implying that the original equipment seats for the automobile are sub-optimal—at least in some applications. The goal in engineering a replaceable wheelchair seat would seem to be, above all, that the seat “rides well” as determined by its user community.

The removable and replaceable wheelchair seats in accordance with the present invention will be seen to satisfy these diverse requirements and objectives.

### SUMMARY OF THE INVENTION

The present invention contemplates a wheelchairs having and attaching each of multiple seats.

The seats are selectable by the user-purchaser of the wheelchair, and span the gamut from (1) an advancing two-piece folding, strap-stabilized, fiberglass or plastic, lightweight, deep bowl “sports” seat to (2) fine leather or fabric upholstered seats that are suitable for the most formal occasions. The intent of the replaceable and substitutable seats is to quickly and economically (1) selectively add selective color and style to a wheelchair otherwise persisting in a typically nondescript form, to (2) enhance the performance of the wheelchair which may be at times be in use for sports—such as wheelchair racing or wheelchair basketball—and at other times be in use for formal occasions—such as business and banquets—, and to (3) permit the wheelchair to be better personalized by its user-owner, who need only select and change the seat as opposed to making more permanent modifications to the wheelchair frame, or attachments to the frame.

Each and any of the multiple wheelchair seats are preferably (1) adjustably mounted, (2) replaceable and/or (3) quick connect and disconnect.

### 1. A Wheelchair Selectively Mounting a Plurality of Different Wheelchair Seats

Accordingly in one of its aspects the present invention is embodied in a wheelchair having a plurality of different wheelchair seats sold as a unit in accompaniment to a new wheelchair, the plural seats being selectively attachable one at a time so as to customize seating upon and within the wheelchair as then best suits the preference of the user-occupant of the wheelchair.

At least one of the plurality of selectively attachable wheelchair seats is preferably a substantially flat upholstered seat well suited for formal occasions but substantially unsuitable for sport.

At least another one of the plurality of selectively attachable wheelchair seats is preferably a bucket seat well suited for sport but substantially unsuitable for formal occasions. This bucket seat most preferably has (1) a deep contoured seating surface with sidewalls extending at least ______ inches above a contour base; hinged to (2) a contour back.

Still more preferably the contoured hinged bucket seat further includes a strap between each sidewall of the contoured seating surface and the back limiting the angular extension of the hinged back from the seating surface. By this construction, and this coaction, the entire bucket seat may be maintained in reasonable configuration to support a user-occupant of the wheelchair during use of the wheelchair in sport.

The wheelchair normally has a frame where each of the plurality of selectively attachable wheelchair seats are adjustably mounted to the wheelchair frame. Each of the plurality of selectively attachable wheelchair seats are preferably individually replaceable. Each of the plurality of selectively attachable wheelchair seats are preferably quick connect and disconnect in their attachment to the wheelchair frame.

### 2. A Deep Bucket Wheelchair Seat Constraining a Seated Occupant Against Lateral Movement(s)

In another of its aspects the present invention is embodied in a wheelchair seat having (1) a deep-bucket first-seat-part having a substantially flat base and three high sides receiving and partially enclosing and supporting the buttocks and the lower back below the tail bone and the upper thighs of a wheelchair occupant seated upon the first-seat-seat; attached to (2) a contoured-back second-seat-part having side wings receiving and partially enclosing and supporting a back and a two sides of the torso of the wheelchair occupant seated upon the first-seat-part and leaning back against the second-seat-part. The first-seat-part and the second-seat-part in combination provide lateral support to the wheelchair occupant who is seated upon the first-seat-part and leaning back against the second-seat-part.

The second-seat part is preferably hinged to the first-seat-part.

The seat preferably has two straps connecting second-seat part in its upper regions to the first-seat-part in its forward regions to limit the hinging motion in a backwards direction of the second-seat part relative to the first-seat-part.

The wheelchair seat is preferably mountable to the same location on the same wheelchair where at other times a substantially planar seat without occupant-supporting contours is mounted.

These and other aspects and attributes of the present invention will become increasingly clear upon reference to the following drawings and accompanying specification.

### BRIEF DESCRIPTION OF THE DRAWINGS

FIG. 1 is an exploded perspective view of a first preferred embodiment of a wheelchair in accordance with the present invention having a first-type, standard formal seat removably attached.

FIG. 2 is an exploded perspective view of a first variant of a second preferred embodiment of a wheelchair in accordance with the present invention having a second-type, sport, seat ready to be (removably) attached.

FIG. 3 is an exploded perspective view of the first and the second preferred embodiments of a wheelchair in accordance with the present invention previously seen in FIGS. 1 and 2 now more particularly showing its adjustable seat attachment mechanism.

### DESCRIPTION OF THE PREFERRED EMBODIMENT

1. Wheelchairs and Wheelchair Seats in Accordance with the Present Invention

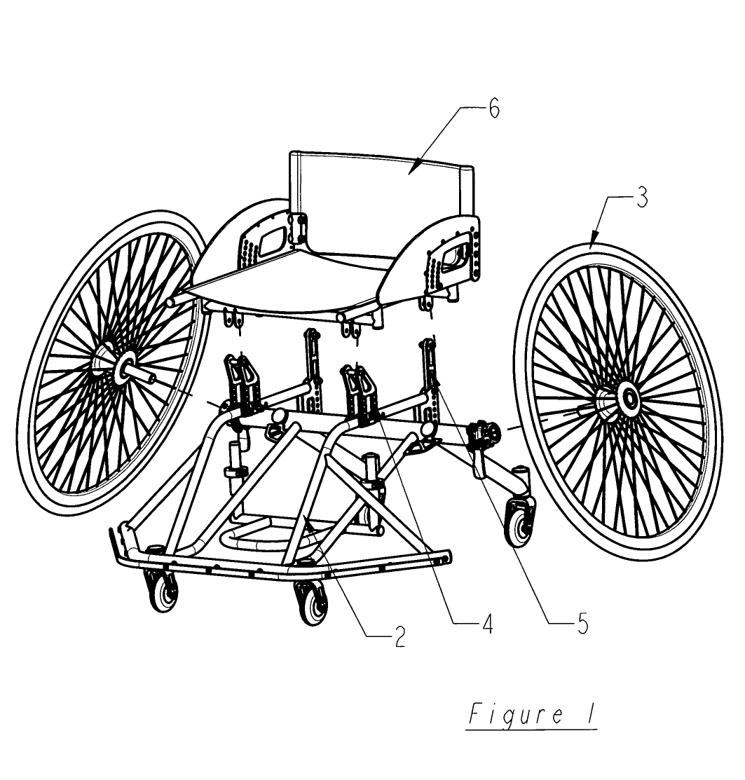

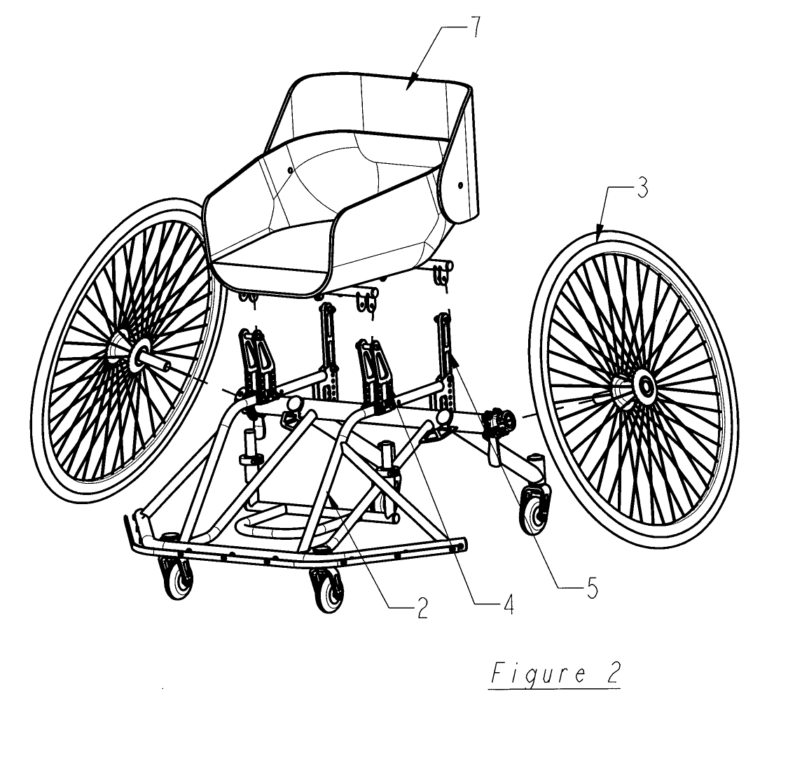

An exploded perspective view of a preferred embodiment of a first preferred embodiment of a wheelchair in accordance with the present invention with a first-type, standard formal seat positioned for adjustable attachment is shown in FIG. 1, and a similar second preferred embodiment of a wheelchair in accordance with the present invention now with a second-type, sport, seat positioned for attachment is shown in FIG. 2.

In both figures the identification numerals within the first column of the following table are assigned to the respective parts that are described within the second column, with the number of such parts used within the complete wheelchair being given in the third column:

TABLE OF PARTS

| IDENTIFICATION | | QUAN- |
|---|---|---|
| NUMBER | DESCRIPTION | TITY |
| 2 | FRAME | 1 |
| 3 | WHEELS | 2 |
| 4 | FRONT SEAT SUPPORT MEMBERS | 2 |
| 5 | REAR SEAT SUPPORT MEMBERS | 2 |
| 6 | FIRST TYPE, FORMAL, SEAT | 1 |
| 7 | SECOND TYPE, SPORT, SEAT | 1 |

A complete table of parts, including additional parts, not identified by numbers in the drawings, which may be used in the construction is as follows.

COMPLETE TABLE OF PARTS

| DESCRIPTION | QUANTITY |
|---|---|
| CAMBER PLATE | 2 |
| CASTER ASSEMBLY | 4 |
| LOCK BARREL | 2 |
| LOCK LOCKNUT | 2 |
| LOCK WASHER | 2 |
| FOOTREST | 1 |
| FRAME | 1 |
| HEXNUT, NYLOC 6-32 | 8 |
| HEXNUT, NYLOC ¼-20 | 10 |
| PLASTIC SEAT, 15.5″ | 1 |
| SADDLE SPACER, ¾″ | 4 |
| SAE WASHER #6 SCREW | 8 |
| SEAT FRAME PLASTIC | 1 |
| SEAT LINK REAR | 2 |
| SEAT LINK, FRONT | 2 |
| SHAFT COLLAR, 1″ | 2 |
| SHCS ¼-20 × 1 | 6 |
| SHCS ¼-20 × 1¾ | 4 |
| SHCS, 6-32 × .500 | 8 |
| TUBE CAP, 1.125 × 1.25 | 4 |
| TUBE SLEEVE, ¾ IN 1″ × .049 SLTD | 2 |
| WASHER ¼-20 ZINC PLATED STEEL | 10 |
| WHEEL, M590, 26″ × 1.375″ | 2 |

2. A Wheelchair in Accordance with the Present Invention Having a First-Type, Standard Formal Seat

A perspective view of a first preferred embodiment of a wheelchair in accordance with the present invention having a first-type, standard formal seat 6 ready for attachment is shown in FIG. 1.

3. A Wheelchair in Accordance with the Present Invention Having a Second-Type, Sport, Seat

A perspective view of a first variant of a second preferred embodiment of a wheelchair in accordance with the present invention having a second-type, sport, seat 7 ready for attachment is shown in FIG. 2.

The detachable sport seat 7 has in particular a deep contour seat base hinged to a deep contour seat back, providing thus substantial lateral support to a seated occupant of the wheelchair.

4. The Wheelchair in Accordance with the Present Invention Having the First-Type, Formal, Seat Shown in Exploded View

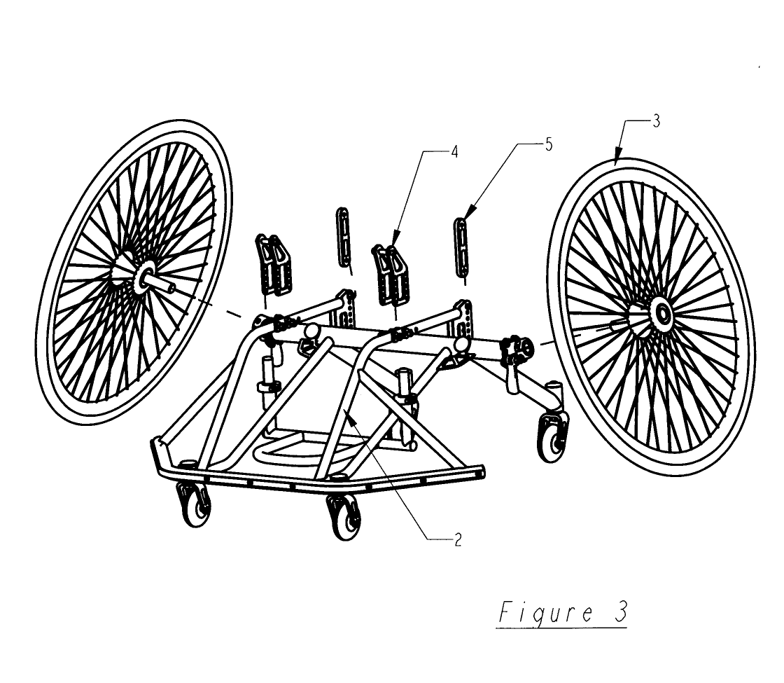

An exploded perspective view of the first preferred embodiment of a wheelchair in accordance with the present invention previously seen in FIGS. 1 and 2 now more particularly exposing the adjustable seat attachment mechanism consisting of two (2) front seat support members 4 and two (2) rear seat support members 4 is shown in FIG. 3.

All parts are preferably removably attached to each other by nuts and bolts, as appropriate.

According to these variations, and still others within the skill of a practitioner of the wheelchair design arts, the present invention should be considered in accordance with the following claims, only, and not solely on accordance with those embodiments within which the invention has been taught.

What is claimed is:

1. A wheelchair comprising:
a plurality of different wheelchair seats, sold as a unit in accompaniment to a new wheelchair, that are selectively attachable one at a time so as to customize seating upon and within the wheelchair as then best suits the preference of the user-occupant of the wheelchair.

2. The wheelchair according to claim 1 wherein at least one of the plurality of selectively attachable wheelchair seats is a substantially flat upholstered seat well suited for formal occasions but substantially unsuitable for sport.

3. The wheelchair according to claim 1 wherein at least another one of the plurality of selectively attachable wheelchair seats is a bucket seat well suited for sport but substantially unsuitable for formal occasions.

4. The wheelchair according to claim 3 wherein the bucket seat comprises:
a deep contoured seating surface with sidewalls extending at least three inches above a contour base; hinged to a contour back.

5. The wheelchair according to claim 3 wherein the contoured hinged bucket seat further comprises:
a strap between each sidewall of the contoured seating surface and the back limiting the angular extension of the hinged back from the seating surface;
wherein entire bucket seat may be maintained in reasonable configuration to support a user-occupant of the wheelchair during use of the wheelchair in sport.

6. The wheelchair according to claim 1 having a frame
wherein each of the plurality of selectively attachable wheelchair seats are adjustably mounted to the wheelchair frame.

7. The wheelchair according to claim 1 having a frame
wherein each of the plurality of selectively attachable wheelchair seats are individually replaceable.

8. The wheelchair according to claim 1 having a frame
wherein each of the plurality of selectively attachable wheelchair seats are quick connect and disconnect in their attachment to the wheelchair frame.

9. A wheelchair selectively at times mounting each of a plurality of different wheelchair seats, one at a time, so as to customize seating upon and within the wheelchair as then best suits the preference of the user-occupant of the wheelchair.

10. A wheelchair seat comprising:
a deep-bucket first-seat-part having a substantially flat base and three high sides receiving and partially enclosing and supporting the buttocks and the lower back below the tail bone and the upper thighs of a wheelchair occupant seated upon the first-seat-seat; attached to
a contoured-back second-seat-part having side wings receiving and partially enclosing and supporting a back and a two sides of the torso of the wheelchair occupant seated upon the first-seat-part and leaning back against the second-seat-part;
wherein the first-seat-part and the second-seat-part do in combination provide lateral support to the wheelchair occupant who is seated upon the first-seat-part and leaning back against the second-seat-part.

11. The wheelchair seat according to claim 10
wherein the second-seat part is hinged to the first-seat-part.

12. The wheelchair seat according to claim 11 further comprising:
two straps connecting second-seat part in its upper regions to the first-seat-part in its forward regions to limit the hinging motion in a backwards direction of the second-seat part relative to the first-seat-part.

13. The wheelchair seat according to claim 10 that is mountable to the same location on the same wheelchair where at other times a substantially planar seat without occupant-supporting contours is mounted.
